(19) United States
(12) Patent Application Publication
(10) Pub. No.: US 2024/0288409 A1
(43) Pub. Date: Aug. 29, 2024

(54) MULTIRESIDUAL METHOD FOR DETECTING AND/OR QUANTIFYING AMINO ACIDS, ORGANIC ACIDS AND/OR MODIFIED NUCLEOTIDES BY MEANS OF HILIC CHROMATOGRAPHIC SEPARATION AND MS/MS

(71) Applicant: CRESCENDO CARE S.R.L., Milano (IT)

(72) Inventors: Francesco Chiara, Milano (IT); Simona Roggero, Milano (IT)

(21) Appl. No.: 18/571,782

(22) PCT Filed: Jun. 20, 2022
(86) PCT No.: PCT/IB2022/055714

§ 371 Date: Dec. 19, 2023

(30) Foreign Application Priority Data
Jun. 22, 2021 (IT) 102021000016364

(51) Int. Cl. G01N 30/88; G01N 30/02; G01N 30/06; G01N 30/72

(52) U.S. Cl. CPC G01N 30/88; G01N 30/06; G01N 30/72; G01N 2030/027; G01N 2030/062; G01N 2030/8818; G01N 2030/8822; G01N 2030/8827

(57) ABSTRACT

The present invention relates to a multiresidual method for detecting and/or quantifying at least one amino acid or derivative thereof, at least one organic acid, and/or at least one modified nucleotide, in a sample of biological liquid or circulating cells, comprising the steps of: a) treating the sample with an extraction mixture at room temperature, preferably refrigerated at a temperature lower than −20° C., comprising i) a mixture of one or more organic solvents having a final polarity index between 3 and 6, ii) a strong acid in an amount sufficient for the extraction mixture to have a normality from 0.005 to 0.025 N or a weak acid with ka in the range between 3.5×10−7 and 7.0×10−3 with a final concentration in the extraction mixture from 5 to 30 mM; wherein the extraction mixture comprises: acetonitrile, dichioromethane and formic acid; or acetonitrile and hydrochloric acid; or acetone and formic acid; or methanol and formic acid; or acetonitrile and formic acid; or methanol and dimethyl sulfoxide; or acetonitrile and dimethyl sulfoxide; or acetonitrile, methanol and hydrochloric acid; or acetonitrile and methanol; b) performing a hydrophilic interaction liquid chromatography (HILIC) on the sample treated in step a); c) performing an analysis by tandem mass spectrometry on the sample obtained in step b) detecting and/or quantifying the at least one amino acid or derivative thereof, and/or the at least one organic acid, and/or the at least one modified nucleotide.

### CROSS-REFERENCE TO RELATED APPLICATIONS

This patent application claims priority from Italian Patent Application No. 102021000016364 filed on Jun. 22, 2021, the entire disclosure of which is incorporated herein by reference.

### TECHNICAL FIELD OF THE INVENTION

The present invention relates to a multiresidual method for detecting and/or quantifying at least one amino acid or derivative thereof, and/or at least one organic acid, and/or at least one modified nucleotide, in a sample of biological fluid or circulating cells.

### STATE OF THE ART

The possibility of detecting and quantifying target metabolites as useful tests for the differential diagnosis of multiple diseases, in particular metabolic and, more specifically, hereditary diseases, is gaining in importance. Compliance with the UNI EN ISO/IEC 17025:2018 standard is also fundamental.

To date, there are no methods on the market, nor described in the literature, that allow the simultaneous measurement of analytes such as amino acids, organic acids and modified nucleotides in panels, in particular as they occur naturally in the sample in their natural oxidation/reduction state. The diagnostic trend for these metabolites is increasing, due to the greater screening offer, for the increasingly clear correlations of these analytes with specific diseases, and thus also the recognised clinical impact and demand for multiple and comprehensive marker panels.

Some methods, with a similar diagnostic objective to that of the present invention, have been described. However, these methods differ technically and in any case they are not as effective (accuracy, type of measurable analytes, and detection times).

A first example is that reported in Sutton T R et al, Redox Biology (2018); 16:359-380, wherein the objective is to determine the redox metabolism linked to thiol compounds. However, the method is limited to identifying thiols.

Another example is that reported in Behringer S et al., Metabolites (2019); 9, 235, wherein the metabolic cycle of methionine is investigated. As only amino acids that are part of the methionine metabolic cycle are analysed, no steps are required to overcome the oxidation problem that other metabolites other than methionine have. However, the analytes that can be measured by this method are very limited.

CN110542726 describes a method HILIC-UHPLC-MS/MS for determining the content of some analytes in human cell samples to evaluate small cell lung cancers. However, this method only allows a limited number of amino acids to be identified.

CN107843672 discloses a method for detecting an amino acid in serum using high-performance liquid chromatography and tandem mass spectrometry. An isotopic amino acid is added to a serum sample for use as an internal standard. Subsequently, the amino acid in the sample is extracted by a liquid-liquid extraction method, the amino acid is separated by HILIC and a method based on a standard-internal standard curve is used for analysis by tandem mass spectrometry.

Other multiresidual measurement methods for the same analytes object of the patent, which are nowadays available in the laboratory today, involve numerous passages, long times and limited accuracy.

None of the above methods, however, allows the analysis of a sufficiently broad panel of analytes comprising amino acids, organic acids and modified nucleotides and is applicable to different types of sample (biological fluid and cells).

The gold standard used in the laboratory for sulphur amino acids is for example HPLC with fluorimetric detection and post-column derivatisation with ninhydrin which requires at least 2.5 working hours.

### SUBJECT AND SUMMARY OF THE INVENTION

It is therefore an aim of the present invention to provide a method for analysing a broad panel of analytes, including amino acids, organic acids and modified nucleotides, in particular as they occur naturally in the sample in their natural oxidation/reduction state, that works on both biological liquid and cells, and that is efficient, reliable and fast.

This aim is achieved by the present invention as it relates to a method as defined in claim 1.

### BRIEF DESCRIPTION OF THE DRAWINGS

FIGS. 1A and 1B represent chromatograms indicating the homocysteine dosage according to the invention with reference to a preferred embodiment.

FIGS. 2A and 2B represent chromatograms indicating the cysteine dosage according to the invention with reference to a preferred embodiment.

FIG. 3 represents a chromatogram indicating a panel of concurrently dosed analytes.

FIGS. 4A and 4B represent chromatograms indicating the glutathione (GSH) dosage according to the invention with reference to a preferred embodiment.

FIGS. 5A and 5B represent chromatograms indicating the glutathione disulfide (GSSG) dosage according to the invention with reference to a preferred embodiment.

FIG. 6 represents a chromatogram indicating the N-acetylcysteine dosage according to the invention with reference to a preferred embodiment.

FIG. 7 represents a chromatogram indicating the S-adenosylhomocysteine dosage according to the invention with reference to a preferred embodiment.

FIG. 8 represents a chromatogram indicating the lipoic acid dosage according to the invention with reference to a preferred embodiment.

FIG. 9 represents a chromatogram indicating the S-adenosylmethionine dosage according to the invention with reference to a preferred embodiment.

FIG. 10 represents a chromatogram indicating the metanephrine dosage according to the invention with reference to a preferred embodiment.

FIG. 11 represents a diagram of the method according to a preferred embodiment of the invention.

FIG. 12 represents a chromatogram indicating the cysteine NEM dosage according to the invention with reference to a preferred embodiment wherein the extraction mixture is based on acetonitrile, methanol and hydrochloric acid (0.05 normal).

FIG. 13 represents a chromatogram indicating the N-acetylcysteine dosage according to the invention with reference to a preferred embodiment wherein the extraction mixture is based on acetonitrile, methanol and hydrochloric acid (0.05 normal).

FIG. 14 represents a chromatogram indicating the homocysteine dosage according to the invention with reference to a preferred embodiment wherein the extraction mixture is based on methanol and dimethyl sulfoxide (0.05% v/v).

### DETAILED DESCRIPTION OF PREFERRED EMBODIMENTS OF THE INVENTION

According to the present invention there is provided a multiresidual method for detecting and/or quantifying at least one amino acid or derivative thereof, at least one organic acid, and/or at least one modified nucleotide, in a sample of biological liquid or circulating cells, comprising three steps (a), b) and c)) in sequence.

“Multiresidual” means an effective method for detecting panels of multiple analytes at low concentrations. In particular, all analytes can be run in one single chromatographic run.

Preferably, at least one amino acid or derivative thereof, at least one organic acid or derivative thereof, and at least one modified nucleotide or derivative thereof are detected and/or quantified. In particular, these molecules are detected and/or quantified as they occur naturally in the sample in their natural oxidation/reduction state.

The at least one amino acid can be a polar, non-polar, acidic, basic, neutral, sulphur or special amino acid, or a dipeptide or tripeptide derivative. The at least one amino acid or derivative thereof is preferably selected from the group consisting of phosphoserine, threonine, serine, glutamine, glycine, alanine, cysteine, valine, cystine, methionine, methionine sulfone, methionine sulfoxide, formylmethionine, cystathionine, isoleucine, leucine, norleucine, tyrosine, β-alanine, phenylalanine, homocysteine, homocystine, lysine, ornithine, histidine, 1-methylhistidine, 3-methylhistidine, anserine, arginine, proline, citrulline, glutathione, glutathione disulphide, cysteine sulphide, N-acetylcysteine, taurine, Selenium-methionine, phosphoethanolamine, homocitrulline, sarcosine, asparagine, carnosine, hydroxyproline, hydroxylisine, homocysteine lactone, cysteine homocysteine, tryptophan, homoglutathione, aminoethylecysteine, selenocysteine.

In a preferred embodiment, the at least one organic acid is a short chain C2-C8 organic acid. The at least one organic acid is preferably selected from the group consisting of cysteic acid, pyruvic acid, lactic acid, lipoic acid, α-aminobutyric acid, γ-aminobutyric acid, glutamic acid, aspartic acid, aminoadipic acid, argininosuccinic acid, sulfhydric acid.

The at least one modified nucleotide is preferably selected from the group consisting of s-adenosylmethionine, s-adenosylhomocysteine and acetylCoA.

In a preferred embodiment, the method may detect at least one amino acid and/or at least one organic acid and/or at least one modified nucleotide, and/or other biomolecules (including catecholamines, metanephrines, purine biosynthesis metabolites pyrimidine biosynthesis metabolites, kinurenines), and/or drugs (including NSAIDs such as acetylsalicylic acid, ketorolac, cox 1 and cox2 inhibitors, antiarrhythmics such as lidocaine, tocainide, phleicanide, and antibiotics such as clavulanic acid, tazobactam, vaborbactam).

The first step of the method (step a)) envisages treating the sample with an extraction mixture at room temperature, preferably refrigerated at a temperature lower than −20° C. comprising i) a mixture of one or more organic solvents having final polarity index between 3 and 6, ii) a strong acid in an amount sufficient for the extraction mixture to have a normality from 0.005 to 0.025 N or a weak acid with ka in the range between 3.5×10−7 and 7.0×10−3 with a final concentration in the extraction mixture from 5 to 30 mM.

Optimal results are obtained with a refrigerated extraction mixture at a temperature lower than −20. However, the method provides reliable results even if the extraction mixture is used at room temperature.

The extraction mixture comprises acetonitrile, dichloromethane and formic acid; or acetonitrile and hydrochloric acid; or acetone and formic acid; or methanol and formic acid; or acetonitrile and formic acid; methanol and dimethyl sulfoxide; acetonitrile and dimethyl sulfoxide; acetonitrile, methanol and hydrochloric acid; acetonitrile and methanol.

The extraction mixture preferably comprises acetonitrile (69% v/v), dichloromethane (30% v/v) and formic acid (1% v/v); or acetonitrile and hydrochloric acid (0.015 normal); or acetone (99.5% v/v) and formic acid (0.5% v/v); or methanol (99% v/v) and formic acid (1% v/v); or acetonitrile and formic acid (0.2% v/v); methanol and dimethyl sulfoxide (0.05% v/v); acetonitrile and dimethyl sulfoxide (0.05% v/v); methanol acetonitrile, and hydrochloric acid (0.05 normal); acetonitrile and methanol (50% v/v).

Step a) is preferably preceded by a step of treating the sample with a solution of water, a low-concentration organic solvent and a substance of the group of N-substituted Imides with at least one unsaturation in alpha position with respect to one of the acyl groups, of organic acids with C4 to C10 chain.

The substance of the group of N-substituted Imides is preferably N-ethylmaleimide (NEM) or N-methylmaleimide (NMM), even more preferably N-ethylmaleimide (NEM).

In one embodiment, the sample is a biological liquid, e.g., plasma, urine, saliva, sweat, CSF, amniotic fluid, or whole blood. The biological liquid is preferably plasma.

In an alternative embodiment, the sample consists of circulating cells and the circulating cells are preferably PBMC (peripheral blood mononuclear cells) monocytes. In this case, prior to step a) the cells are separated by a cell separation method known to the person skilled in the art. The cells are then lysed with a solution of water, methanol and N-ethylmaleimide (NEM) and placed at −80° to complete the lysis.

The extraction mixture preferably comprises acetonitrile (69% v/v), dichloromethane (30% v/v) and formic acid (1% v/v); or acetonitrile and hydrochloric acid (0.015 normal); or acetone (99.5% v/v) and formic acid (0.5% v/v); or methanol (99% v/v) and formic acid (1% v/v); or acetonitrile and formic acid (0.2% v/v); or methanol and dimethyl sulfoxide (0.05% v/v); or acetonitrile and dimethyl sulfoxide (0.05% v/v); or acetonitrile, methanol and hydrochloric acid (0.05 normal); acetonitrile and methanol (50% v/v).

The extraction mixture is refrigerated:
from −95° C. to −70° C. if the extraction mixture is preserved for a time longer than or equal to 6 months;
from −25° C. to −15° C. if the extraction mixture is preserved for a time from 2 months to 6 months;
from −30° C. to −20° C. if the extraction mixture is prepared for immediate use.

More particularly, a volume between 50 μl and 200 μl of sample (plasma or lysed cell solution as described above) is dispensed with a precision pipette into an Eppendorf type centrifuge cuvette with minimum capacity of 250 μl; 5 μl to 20 μl of the internal standard solution and subsequently 100 μl to 800 μl of extraction mixture are added to them. This is followed by stirring on vortex for 1 min and by centrifugation in the range of 3500 to 5000 RPM for 10 min.

The second step (step b)) envisages performing a hydrophilic interaction liquid chromatography (HILIC) on the sample treated in step a). The hydrophilic interaction liquid chromatography (HILIC) is performed by means of a step A and a step B between which there is a pH gradient from 2.5 to 7.5 and an ionic strength gradient from 15 mmolar to 200 mmolar such as to allow the separation of the analytes with a single stationary step.

An example of a column for HILIC pack is VT-50 2D Shodex L150×i.d.2.0 mm.

Preferably, step A comprises an organic solvent having a final polarity index between 4 and 7 and water in a volume ratio such that the final polarity index of the mixture is between 3 and 11 taking into account the addition of an acid-base pair with an ion-pair function so as to buffer the entire solution to a pH between 2.5 and 6.

Preferably, step B comprises an organic solvent having a final polarity index between 4 and 7 and water in a volume ratio such that the final polarity index of the mixture is between 7 and 10 taking into account the addition of an acid-base pair with an ion-pair function so as to buffer the entire solution to a pH between 2.5 and 6.

More preferably, the hydrophilic interaction liquid chromatography (HILIC) is performed by means of a step A with water, preferably R=18 MΩ 100% v/v and NH₄COOH, preferably 10 mM followed by a step B with acetonitrile, preferably MS grade 95% v/v and water, preferably R=18 MΩ 5% v/v and NH₄COOH, preferably 10 mM.

Specifically, a suitable volume in the range of 50 μl to 400 μl of the supernatant is diluted in an appropriate ratio (1:2 to 1:20) with “step A” and transferred into vial microinsert and injected into HPLC-MS/MS or UHPLC-MS/MS. The injection sequence envisages in the following order:
three injections of solution prepared in 1:1 volume proportions of the organic solvent used for the preparation of “step B” and water;
the standard solutions prepared in the matrix;
the samples.

The flow is between 0.2 and 0.6 ml/min

The temperature is between 30° C. and 35° C.

Elution is in gradient.

The optimal conditions using the above-described steps and a HILIC-based stationary step are:
Initial conditioning
Time between 0 and 5 minutes
Step B between 70 and 95% v/v
Linear gradient with negative slope in “step A” between 5 and 15% v/v per minute-1 up to a time between 8 and 13 minutes and “step A” between 35 and 5% v/V. A reconditioning step is then envisaged in a time range between 2 and 5 minutes for restoring the initial running conditions.

In particular, an example of optimal conditions is shown in the following table:

| time/min | Step B |
|---|---|
| 0.01 | 100 |
| 1.50 | 100 |
| 6.50 | 5 |
| 8.50 | 5 |
| 9.00 | 100 |
| 11.00 | 100 |

Quantification takes place using the external standard method after normalising the areas of the samples with the areas of the respective internal standards (Aminoethylcysteine and Omoglutathione).

The third step (step c)) envisages performing an analysis by tandem mass spectrometry on the sample obtained in step b) for detecting and/or quantifying the at least one amino acid or derivative thereof, the at least one organic acid, and/or the at least one modified nucleotide.

The analysis by tandem mass spectrometry is carried out with the following parameters Q1 and Q3:

| Substance | Q1 | Q3 |
|---|---|---|
| Alanine | 44.1 | 72.1 |
| Aminoadipic acid | 98.1 | 144.1 |
| Aminobutyric acid | 41.1 | 58.1 |
| Aminoisobutyric acid | 57.1 | 86.1 |
| Hydroxyproline | 68.1 | 86.1 |
| Phosphoserine | 70.1 | 88.1 |
| Phosphoethanolamine | 44.1 | |
| Arginine | 70.1 | 116.1 |
| Hystidine | 110.1 | 83.1 |
| Lysine | 84.1 | 130.1 |
| Aspartic acid | 74.1 | 88.1 |
| Asparagine | 74.1 | 87.1 |
| Glutamine | 84.2 | 130.1 |
| Tryptophan | 146.1 | 188.1 |
| Argininosuccinic acid | 70.1 | 116.1 |
| Anserine | 109.1 | |
| Carnosine | 110.1 | 210.1 |
| Ethanolamine | 44.1 | |
| Hydroxylisine | 82.2 | 128.1 |
| Ornitine | 70.1 | 116.1 |
| Phenylalanine | 120.1 | 103.1 |
| Proline | 70.1 | 43 |
| Leucine | 86.1 | 43.1 |
| Isoleucine | 86.1 | 69.1 |
| Alloisoleucine | 69.1 | 86.1 |
| Homocitrulline | 127.1 | 173.1 |
| Citrulline | 70.1 | 159.1 |
| Sarcosine | 44.1 | |
| Threonine | 74.1 | 102.1 |
| Tyrosine | 136.1 | 165.1 |
| Valine | 72.1 | 55.1 |
| Lipoic acid | 205 | 171 |
| | 205 | 127.1 |
| | 205 | 93 |
| Methionine sulfoxide | 164 | 63 |
| | 164 | 100 |
| | 164 | 149 |
| | 166 | 74 |
| | 166 | 102 |
| | 166 | 149 |
| Cysteine_NEM | 247 | 158 |
| | 247 | 184 |
| | 247 | 230 |
| | 247 | 212 |
| N-acetylcysteine_NEM | 289 | 243 |
| | 289 | 201 |
| | 289 | 158.2 |
| Methionine SO2 | 180 | 79 |
| | 180 | 64 |
| Cysteic acid | 168 | 151 |
| | 168 | 81 |
| | 168 | 71 |
| Glycine | 74 | 45 |
| | 74 | 58 |
| Glutamic acid | 146 | 102 |
| | 146 | 128 |
| Methionine | 150 | 133 |
| | 150 | 104 |
| S-Adenosilhomocysteine | 383.2 | 134 |
| | 383.2 | 188 |
| | 383.2 | 248 |
| | 385 | 136 |
| | 385 | 250 |
| | 385 | 88 |
| Pyruvic Acid | 87 | 43 |
| | 87 | 59 |
| Taurine | 124 | 80 |
| | 124 | 107 |
| Glutathione disulfide | 613 | 355 |
| | 613 | 484 |
| | 613 | 409 |
| | 613 | 538 |
| | 613 | 595 |
| | 611.3 | 306 |
| | 611.3 | 272.3 |
| | 611.3 | 254 |
| | 611.3 | 338 |
| | 611.3 | 143 |
| Glutathione_NEM | 431.1 | 306.3 |
| | 431.1 | 253.8 |
| | 431.1 | 288.2 |
| | 431.1 | 179 |
| | 431.1 | 272.2 |
| | 431.1 | 304.3 |
| | 431.1 | 286.9 |
| | 431.1 | 358.2 |
| | 431.1 | 20 |
| | 431.1 | 211.8 |
| Cysteine Sulfate | 200.3 | 136.1 |
| | 200.3 | 81 |
| | 200.3 | 74 |
| | 200.3 | 120 |
| N-formylmethionine | 176 | 128.1 |
| | 176 | 98 |
| | 176 | 84 |
| S-Adenosilmethionine | 399.3 | 298.1 |
| | 399.3 | 250.2 |
| | 399.3 | 264 |
| Serine | 103.9 | 74 |
| | 103.9 | 56 |
| | 103.9 | 42 |
| Cystathionine | 221 | 134 |
| | 221 | 120 |
| | 221 | 86 |
| Homocysteine-NEM | 261.1 | 215 |
| | 261.1 | 244 |
| Aminoethylcysteine | 165 | 148 |
| | 165 | 120 |
| Homocysteine | 267 | 132 |
| | 267 | 72 |
| | 267 | 115 |
| | 267 | 88 |
| Homoglutathione_NEM | 447.6 | 319 |
| | 447.6 | 301.3 |
| | 447.6 | 200.8 |
| | 447.6 | 358.1 |
| | 445.5 | 157.1 |
| | 445.5 | 286.3 |
| | 445.5 | 174 |
| | 445.5 | 196 |
| | 445.5 | 268.3 |
| | 445.5 | 301.9 |
| Selenomethionine | 197.1 | 95 |
| | 197.1 | 107 |
| | 197.1 | 122 |
| Cysteine | 241.2 | 120 |
| | 241.2 | 122 |
| | 241.2 | 152 |
| | 241.2 | 195 |
| | 241.2 | 223 |
| Homocysteine NMM | 247.1 | 215 |
| | 247.1 | 244 |

Each NEM-analyte or NMM-analyte corresponds to the form of the analyte as it occurs naturally in the sample in the natural oxidation/reduction state and unmodified by external factors (e.g. oxygenation by contact with ambient air), measured thanks to the addition in whole blood of an N-substituted Imide with at least one unsaturation in alpha position with respect to one of the acyl functions, of organic acids with C4 to C10 chain, for example NEM or NMM.

More preferably, an HPLC-(ESI) MS/MS system or a U-PLC-(ESI) MS/MS system is used. Alternatively, MS/MS or MS/TOF or even TOF/TOF or IT-TOF or Q-TOF detection systems.

Preferably, the system must have these characteristics: it must be capable of supporting at least 400 bar Pmax; the detection system must be provided with polarity switching not greater than 10 ms; the HPLC system must be provided with pumps with a minimum of two lines; the column housing must be thermostat-controlled; and the autosampler must be suitable for the injection volumes envisaged by the method (1-10 μl).

The method according to the invention is particularly useful in the diagnosis of metabolic diseases, in particular of a broad spectrum of acute conditions such as acute encephalopathy, and chronic conditions such as the metabolism of the pterines.

The method according to the invention can be used in diagnostic laboratories as an alternative instrument to those existing in ion exchange chromatography (for example, with Biocrom instruments).

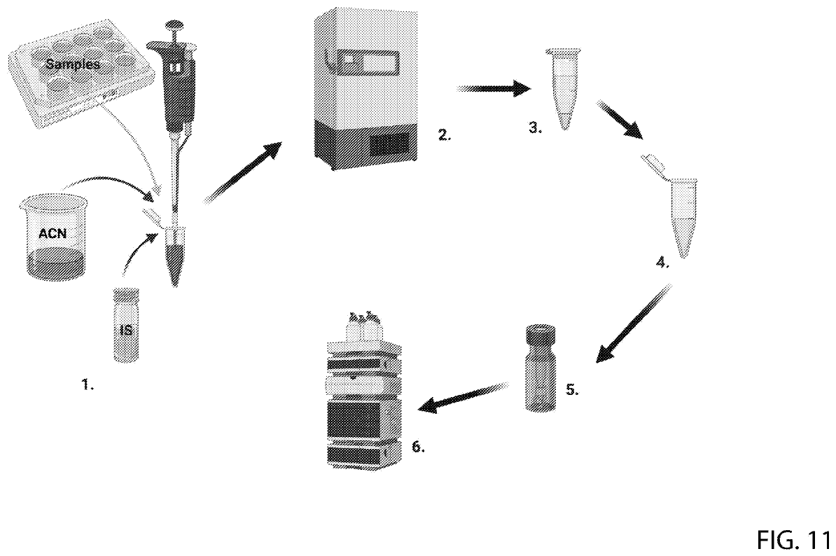

FIG. 11 shows an image of the subsequent steps of the method:
1: mixing the internal standard with the sample, adding the cold solvent. ACN=acetonitrile; IS=internal standard.
2: freezing for 10 minutes.
3: centrifugation at 4000 RPM for 5 minutes.
4: separation of the supernatant.
5: transfer of the supernatant into vial by chromatographic injection.
6: HPLC/MSMS injection.

### Example 1—Homocysteine Measurement

The homocysteine content in a sample of human plasma was measured using the method according to the preferred embodiment described above.

The extraction mixture used was acetonitrile and 0.015 N hydrochloric acid.

It should be noted that to date there is no measurement standard for homocysteine as such, but only for homocysteine disulfide.

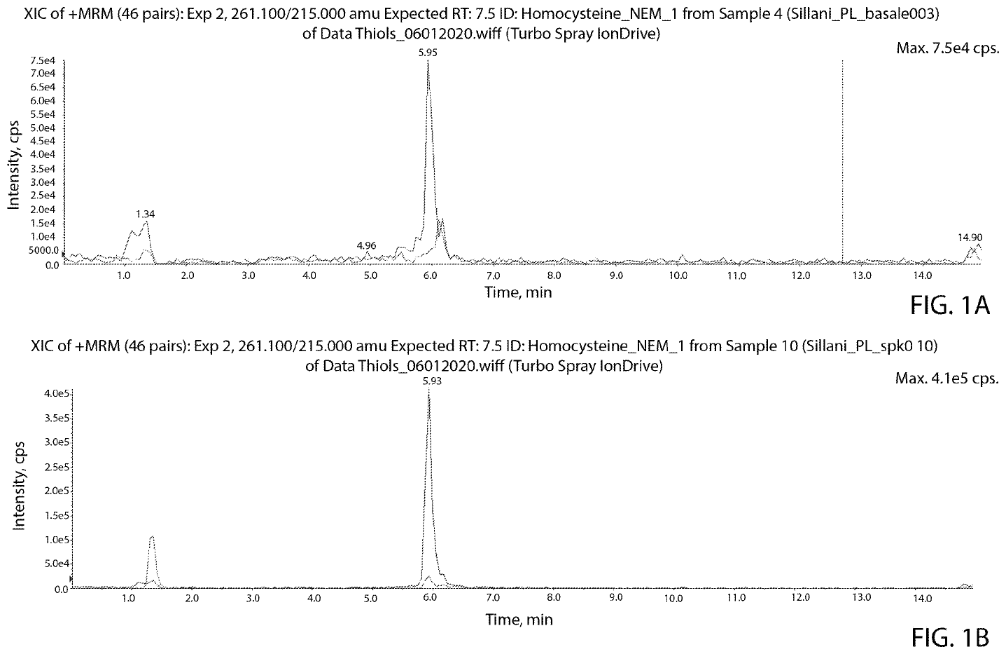

The results are shown in FIGS. 1A and 1B.

### Example 2—Cysteine Measurement

The cysteine content in a sample of human plasma was measured using the method according to the preferred embodiment described above.

The extraction mixture used was methanol (99% v/v) and formic acid (1% v/v).

It should be noted that there is to date no method used in routine hospital practice that allows the determination of the exact amount of cysteine naturally present in the sample analysed.

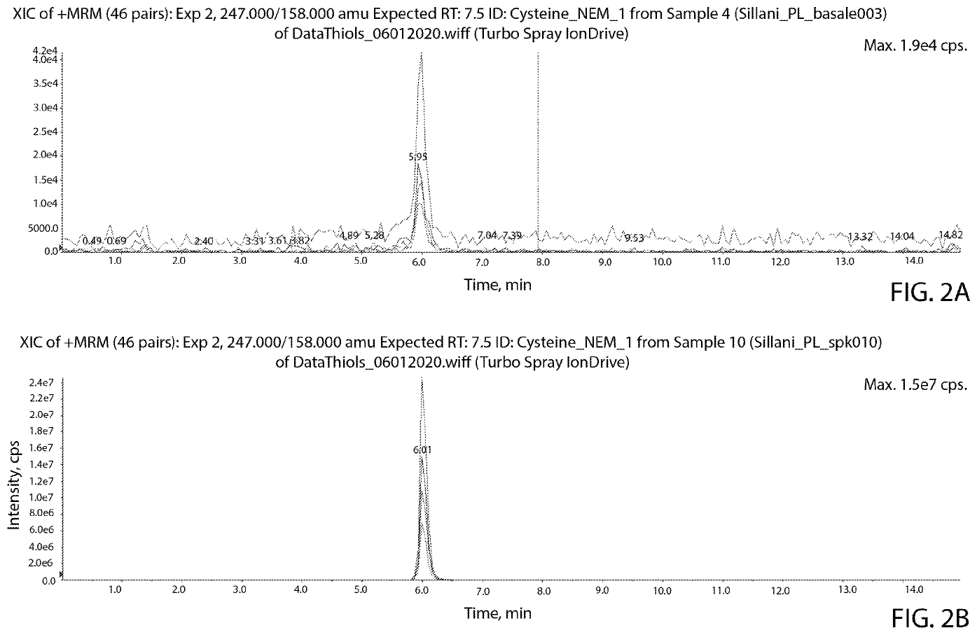

The results are shown in FIGS. 2A and 2B.

### Example 3—Measurement of a Panel of Analytes

The standard mix content 250.0 ppb was measured: (from left to right) methionine, methionine sulphone, cysteic acid, S-adenosylhomocysteine, glutathione-NEM, N-acetylcysteine, glutathione disulphide, using the method according to the preferred embodiment described above in a human plasma sample. The extraction mixture used was acetonitrile (69% v/v), dichloromethane (30% v/v) and formic acid (1% v/v).

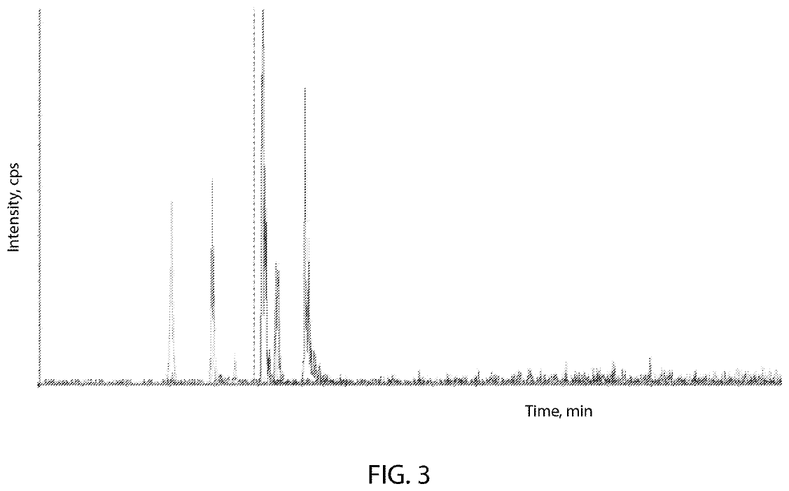

The chromatogram indicating the panel of concurrently dosed analytes is represented in FIG. 3. For the dosed analytes, apart from the first (methionine) and the last (glutathione disulphide), no reference standard exists today.

### Example 4—Glutathione Measurement (GSH)

The glutathione content in a sample of human plasma was measured using the method according to the preferred embodiment described above. The extraction mixture used was acetonitrile (69% v/v), dichloromethane (30% v/v) and formic acid (1% v/v).

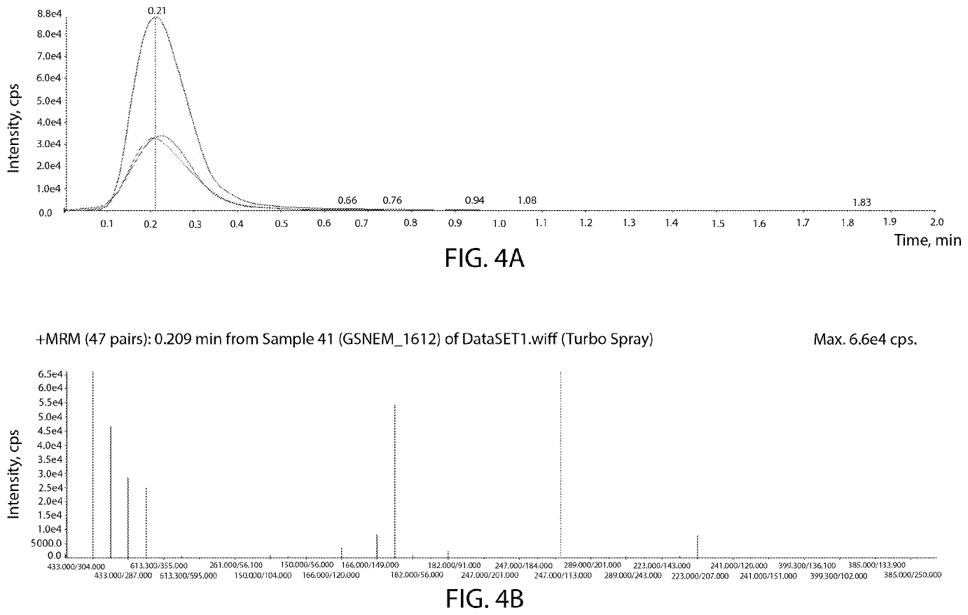

The results are shown in FIGS. 4A and 4B.

### Example 5—Glutathione Disulphide Measurement (GSSG)

The glutathione disulphide content in a sample of human plasma was measured using the method according to the preferred embodiment described above. The extraction mixture used was acetone (99.5% v/v) and formic acid (0.5% v/v).

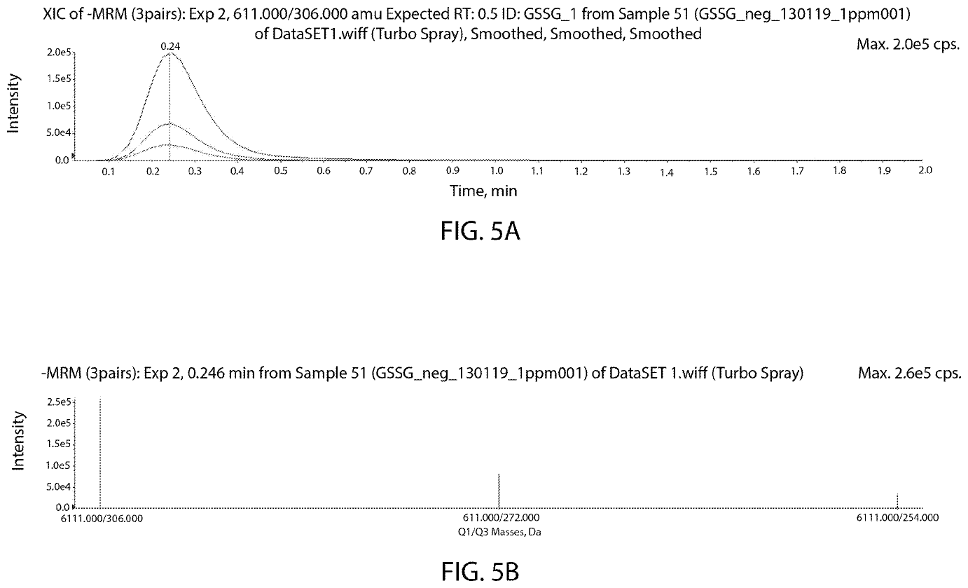

The results are shown in FIGS. 5A and 5B.

### Example 6—N-acetylcysteine Measurement (NAC)

The N-acetylcysteine content in a sample of human plasma was measured using the method according to the preferred embodiment described above. The extraction mixture used was acetonitrile (69% v/v), dichloromethane (30% v/v) and formic acid (1% v/v).

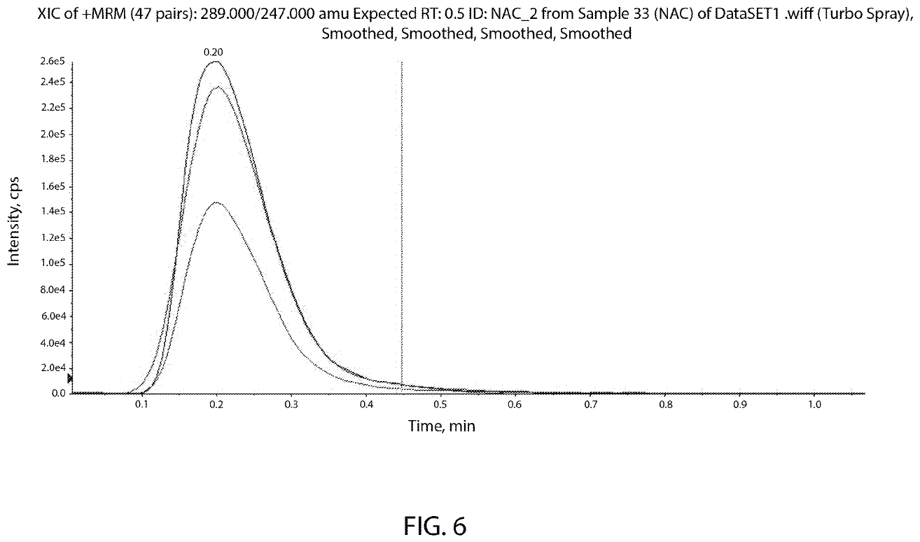

The results are shown in FIG. 6.

### Example 7—S-Adenosylhomocysteine Measurement (NAC)

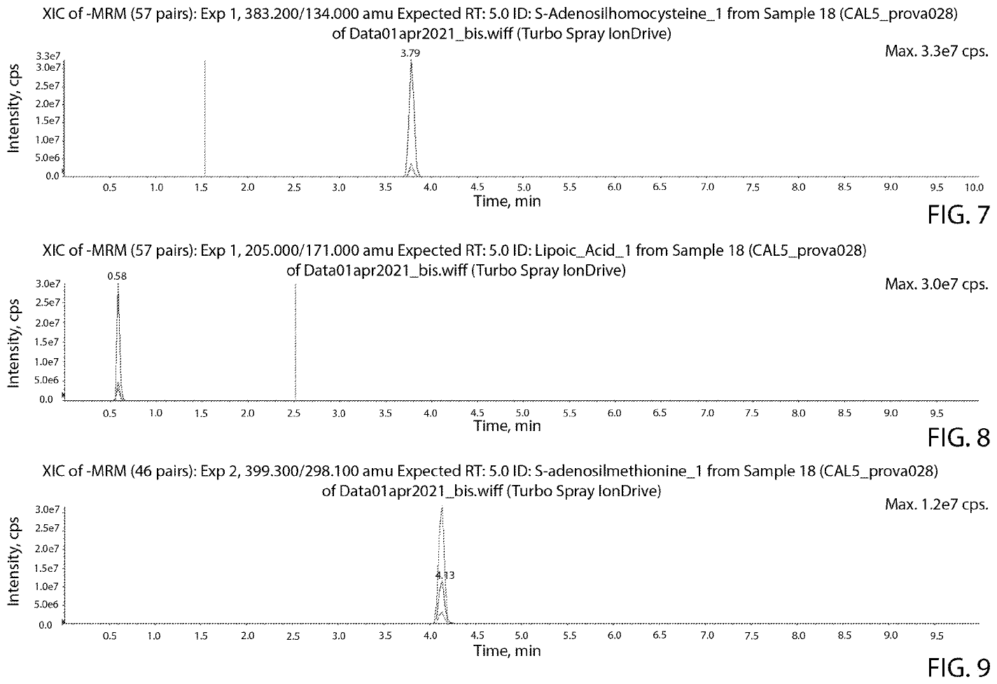

The S-adenosylhomocysteine content in a sample of human plasma was measured using the method according to the preferred embodiment described above. The extraction mixture used was acetone (99.5% v/v) and formic acid (0.5% v/v). The results are shown in FIG. 7.

### Example 8—Lipoic Acid Measurement

The lipoic acid content in a sample of human plasma was measured using the method according to the preferred embodiment described above. The extraction mixture used was acetone (99.5% v/v) and formic acid (0.5% v/v).

The results are shown in FIG. 8.

### Example 9—S-Adenosylmethionine Measurement

The S-adenosylmethionine content in a sample of human plasma was measured using the method according to the preferred embodiment described above. The extraction mixture used was methanol (99% v/v) and formic acid (1% v/v).

The results are shown in FIG. 9.

### Example 10—Metanephrine Measurement

The metanephrine content in a sample of human plasma was measured using the method according to the preferred embodiment described above. The extraction mixture used was methanol (99% v/v) and formic acid (1% v/v).

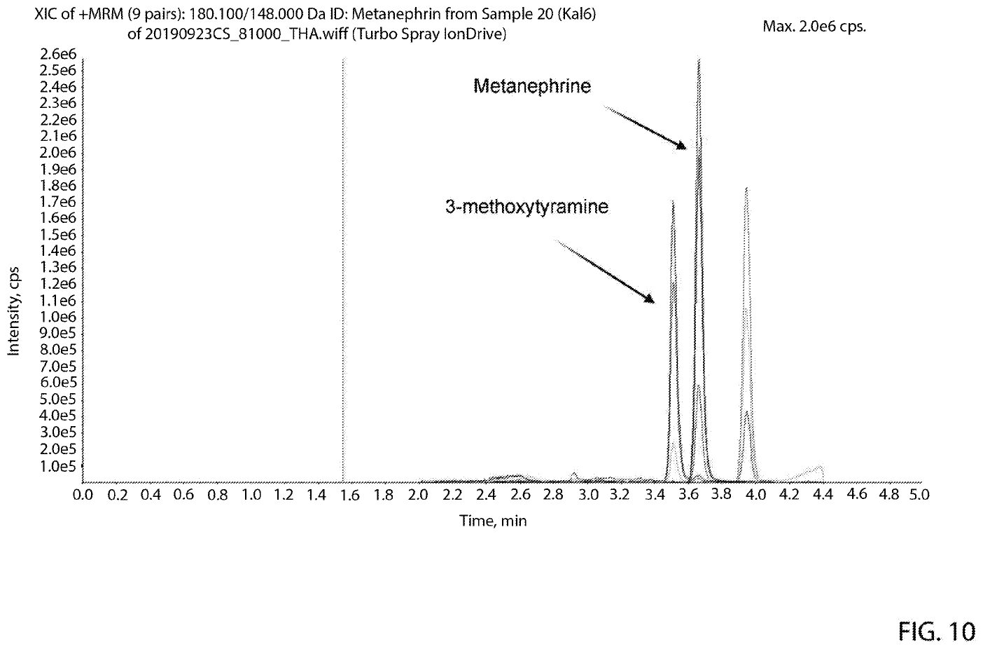

The results are shown in FIG. 10.

### Example 11—NEM Cysteine Measurement

The NEM cysteine content in a sample of human plasma was measured using the method according to the preferred embodiment described above. The extraction mixture used was acetonitrile, methanol and hydrochloric acid (0.05 normal).

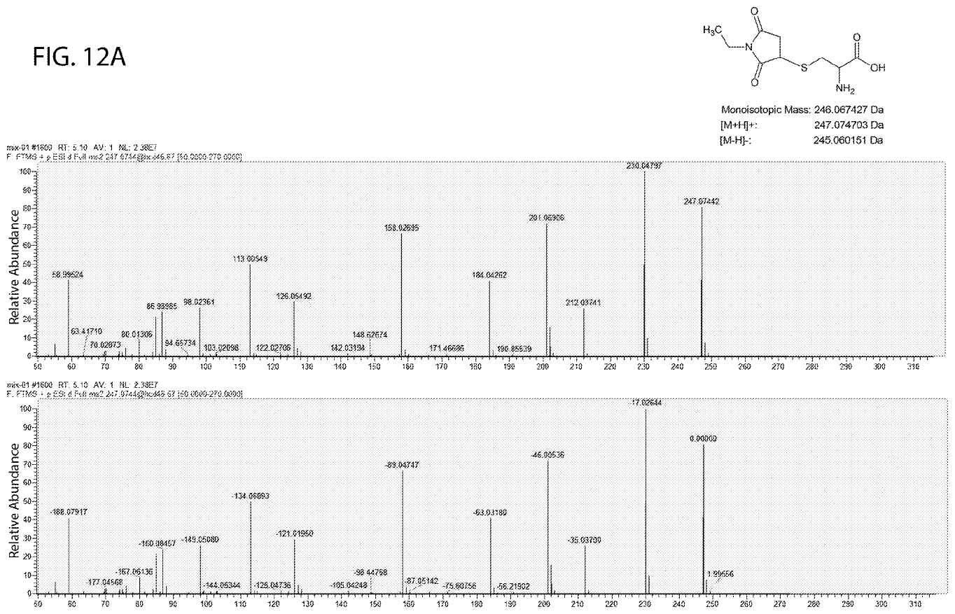

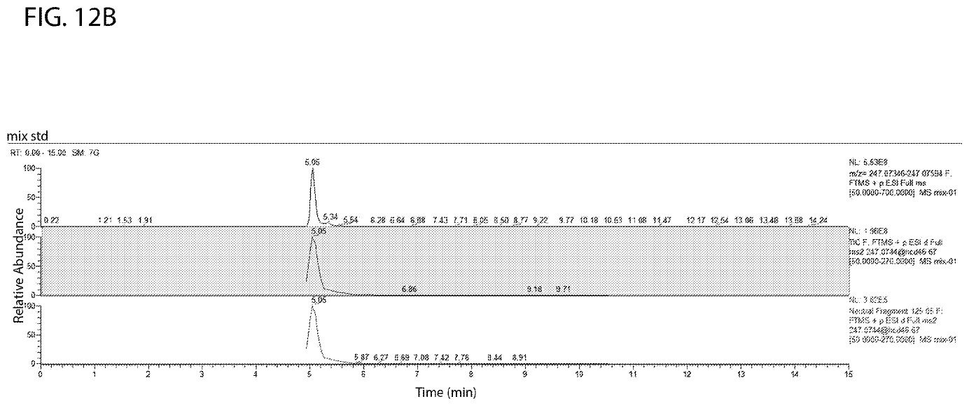

The results are shown in FIG. 12.

### Example 12—N-Acetylcysteine Measurement

The N-acetylcysteine content in a sample of human plasma was measured using the method according to the preferred embodiment described above. The extraction mixture used was acetonitrile, methanol and hydrochloric acid (0.05 normal).

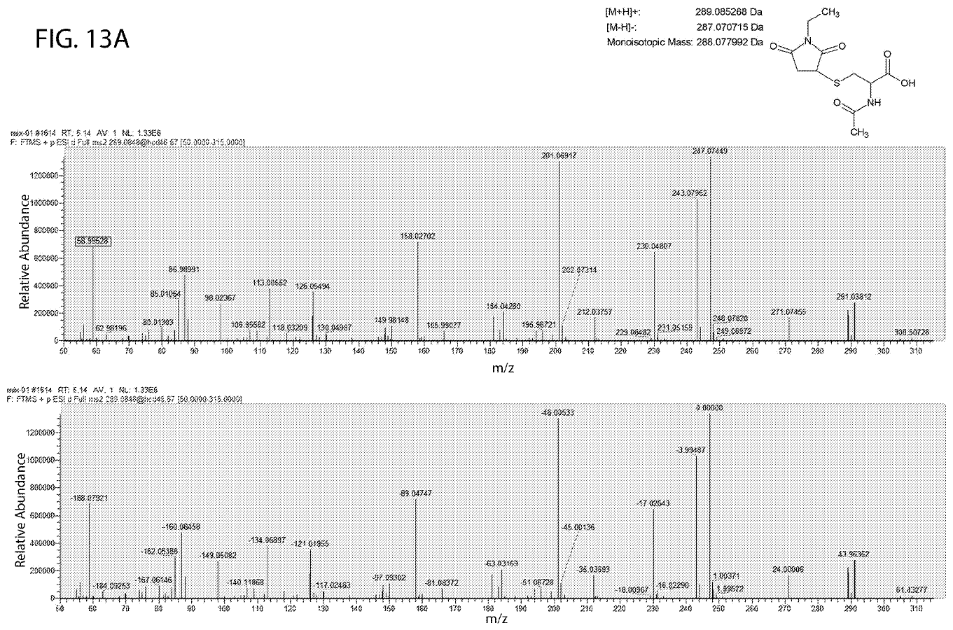

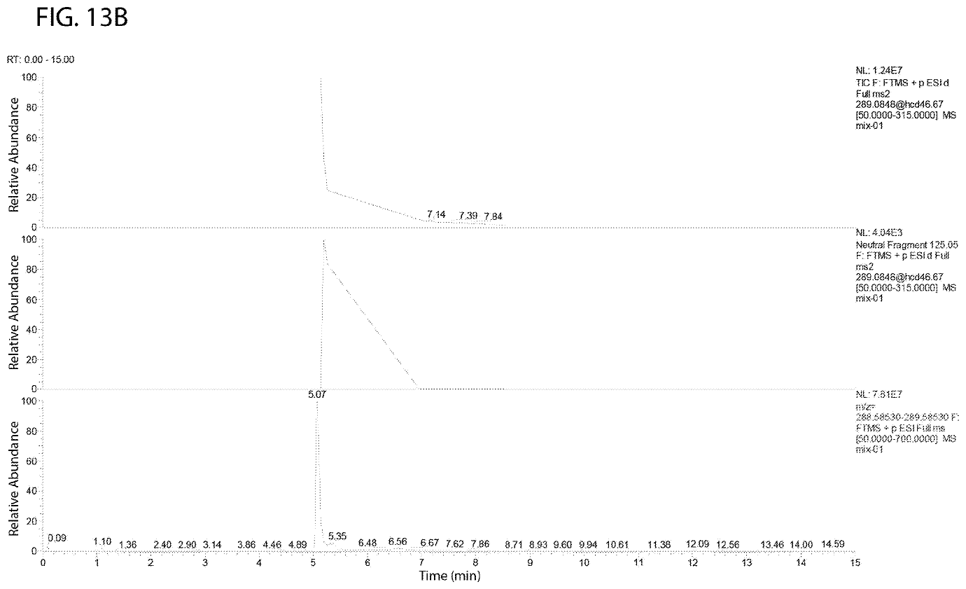

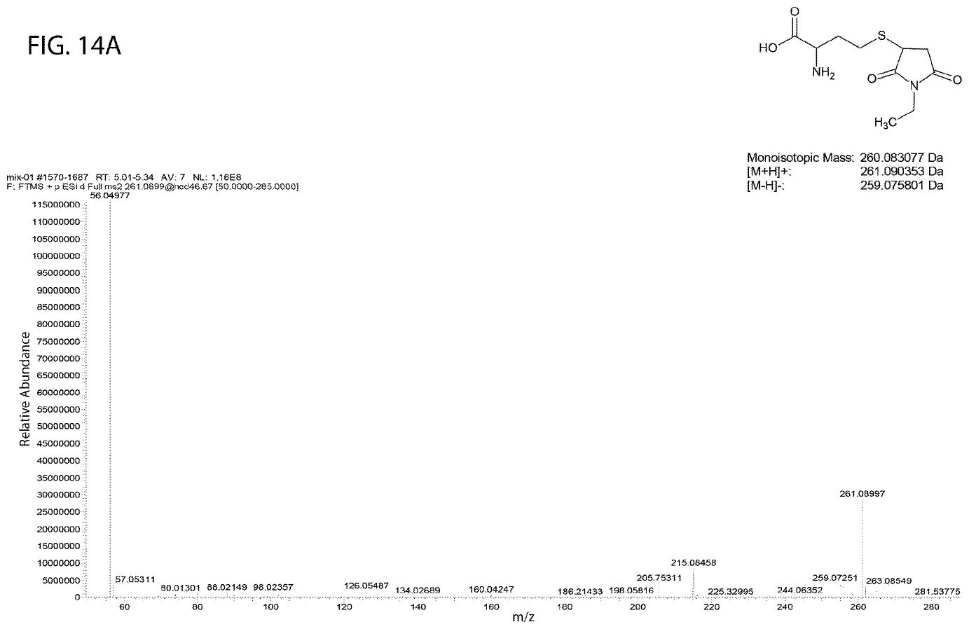

The results are shown in FIG. 13.

### Example 13—Homocysteine Measurement

The homocysteine content in a sample of human plasma was measured using the method according to the preferred embodiment described above. The extraction mixture used was methanol and dimethyl sulfoxide (0.05% v/v).

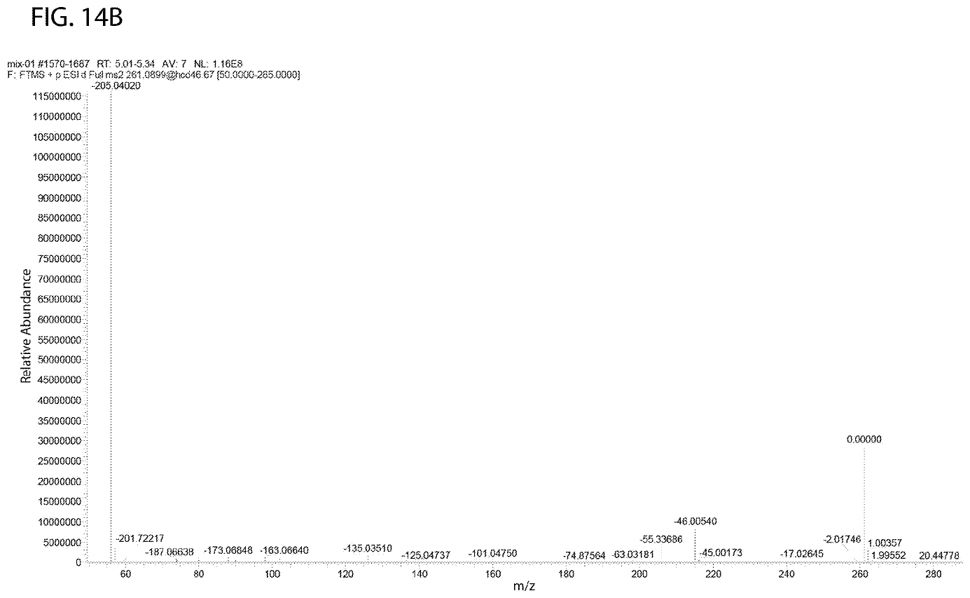

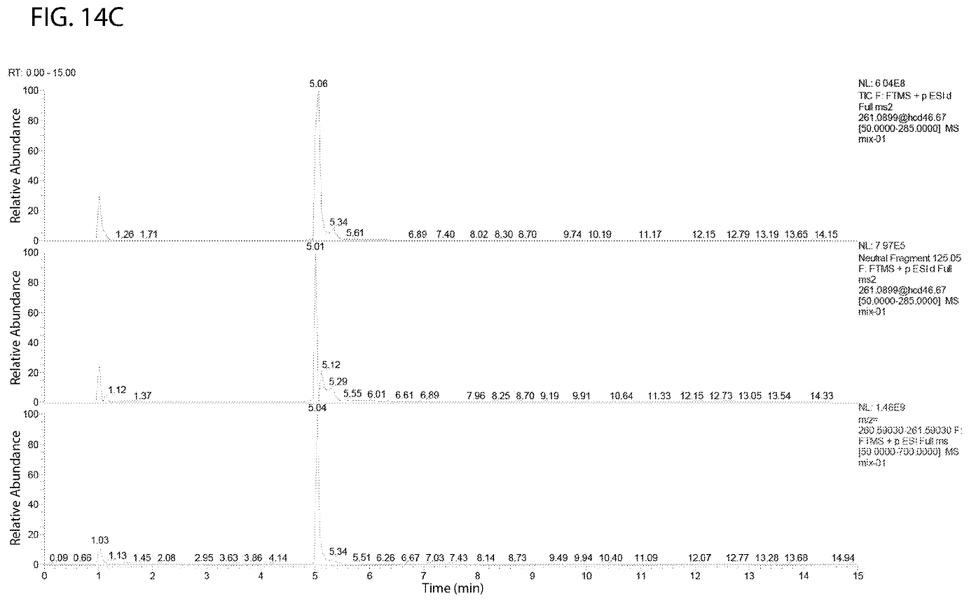

The results are shown in FIG. 14.

### Advantages

The main advantages of the method according to the invention are as follows:
it is the first diagnostic method capable of performing a multiresidual (ppb microg/l) measurement of an extended panel of analytes (amino acids and dipeptide or tripeptide derivatives, short-chain organic acids and modified nucleotides), with a single instrument, significantly reducing the workflow in the laboratory;
it is the first diagnostic method capable of simultaneously quantifying multiple analytes, which are only clinically relevant for many pathological conditions if they are available in panels rather than individually;
for some specific analytes, which can be marked by our method, e.g. REDOX PAIRS (homocysteine/homocystine, cysteine/cystine, glutathione/glutathione disulphide) and cysteine sulphate, it is not possible with the methods currently in use to obtain accurate measurements, or to make quantitative analyses;
for some specific analytes, such as homocysteine lactone and modified nucleotides, it is not possible to have a measurement with any instrument;
in general, for all measurable analytes, the accuracy of the method according to the invention is higher, both in terms of sensitivity and specificity, than the diagnostic methods currently in use;
the method according to the invention is faster than current methods used for single analyte categories. In particular, it allows the entire panel to be marked in less than 30 minutes, whereas current methods take more than 2.5 hours.
no need for additional costs or purchase of instrumentations other than those already in use in the laboratories. In fact, the method according to the invention makes use of a series of reagents and instruments with which laboratories for Level II analyses are provided, but which are not used for this purpose.
The other multiresidual measurements (ppb microg/l) for the same analytes available in the laboratory envisage not only more passages and longer times, but also less accuracy.
The advantage of the method according to the invention over GC-MS (the method of choice for the analysis of organic acids) is that a quantitative analysis is possible and not only a semi-quantitative or qualitative analysis.

Even compared to HPLC with fluorimetric detection and post-column derivatisation with minidrin (the method of choice for sulphur amino acids), the method according to the invention is quantitatively and generally superior in specificity from a technical point of view.

1. A multiresidual method for detecting and/or quantifying at least one amino acid or derivative thereof, at least one organic acid, and/or at least one modified nucleotide,
in a sample of biological liquid or circulating cells, comprising the steps of:
a) treating the sample with an extraction mixture at room temperature, preferably refrigerated at a temperature lower than −20° C. comprising i) a mixture of one or more organic solvents having final polarity index between 3 and 6, ii) a strong acid in an amount sufficient for the extraction mixture to have a normality from 0.005 to 0.025 N or a weak acid with ka in the range between 3.5×10−7 and 7.0×10−3 with a final concentration in the extraction mixture from 5 to 30 mM, wherein the extraction mixture comprises:
acetonitrile, dichloromethane and formic acid; or
acetonitrile and hydrochloric acid; or
acetone and formic acid; or
methanol and formic acid; or
acetonitrile and formic acid; or
methanol and dimethyl sulfoxide; or
acetonitrile and dimethyl sulfoxide; or
acetonitrile, methanol and hydrochloric acid; or
acetonitrile and methanol;
b) performing a hydrophilic interaction liquid chromatography (HILIC) on the sample treated in step a); and
c) performing an analysis by tandem mass spectrometry on the sample obtained in step b) for detecting and/or quantifying the at least one amino acid or derivative thereof, the at least one organic acid, and/or the at least one modified nucleotide.

2. The method according to claim 1, wherein the extraction mixture comprises:
acetonitrile (69% v/v), dichloromethane (30% v/v) and formic acid (1% v/v); or
acetonitrile and hydrochloric acid (0.015 normal); or
acetone (99.5% v/v) and formic acid (0.5% v/v); or
methanol (99% v/v) and formic acid (1% v/v); or
acetonitrile and formic acid (0.2% v/v); or
methanol and dimethyl sulfoxide (0.05% v/v); or
acetonitrile and dimethyl sulfoxide (0.05% v/v); or
acetonitrile, methanol and hydrochloric acid (0.05 normal); or
acetonitrile and methanol (50% v/v).

3. The method according to claim 1, wherein step a) is preceded by a step of treating the sample with a solution of water, a low-concentration organic solvent and a substance of the group of N-substituted imides with at least one unsaturation in alpha position with respect to one of the acyl functions, of organic acids with C4 to C10 chain.

4. The method according to claim 3, wherein the substance of the group of N-substituted imides is N-ethylmaleimide (NEM) or N-methylmaleimide (NMM).

5. The method according to claim 4, wherein the substance of the group of N-substituted imide is N-ethylmaleimide (NEM).

6. The method according to claim 1, wherein at least one amino acid or derivative thereof, at least one organic acid, and at least one modified nucleotide are detected and/or quantified.

7. The method according to claim 1, wherein the sample is biological liquid and the biological liquid selected from the group consisting of plasma, urine, saliva, sweat, CSF, amniotic fluid and whole blood.

8. The method according to claim 1, wherein the sample consists of circulating cells and the circulating cells are PBMC (peripheral blood mononuclear cells) monocytes.

9. The method according to claim 1, wherein the extraction mixture is refrigerated:
from −95° C. to −70° C. if the extraction mixture is preserved for a time longer than or equal to 6 months;
from −25° C. to −15° C. if the extraction mixture is preserved for a time from 2 months to 6 months; or
from −30° C. to −20° C. if the extraction mixture is prepared for immediate use.

10. The method according to claim 1, wherein the at least one organic acid is a short chain C2-C8 organic acid.

11. The method according to claim 1, wherein:
the at least one amino acid or derivative thereof is selected from the group consisting of phosphoserine, threonine, serine, glutamine, glycine, alanine, cysteine, valine, cystine, methionine, methionine sulfone, methionine sulfoxide, formylmethionine, cystathionine, isoleucine, leucine, norleucine, tyrosine, β-alanine, phenylalanine, homocysteine, homocystine, lysine, ornithine, histidine, 1-methylhistidine, 3-methylhistidine, anserine, arginine, proline, citrulline, glutathione, glutathione disulphide, cysteine sulphide, N-acetylcysteine, taurine, Selenium-methionine, phosphoethanolamine, homocitrulline, sarcosine, asparagine, carnosine, hydroxyproline, hydroxylisine, homocysteine lactone, cysteine homocysteine, homoglutathione, aminoethylecysteine, tryptophan, and selenocysteine;
the at least one organic acid is selected from the group consisting of cysteic acid, pyruvic acid, lactic acid, lipoic acid, α-aminobutyric acid, γ-aminobutyric acid, glutamic acid, aspartic acid, aminoadipic acid, argininosuccinic acid, and sulfhydric acid; and
the at least one modified nucleotide is selected from the group consisting of s-adenosylmethionine, s-adenosylhomocysteine and acetylCoA.

12. The method according to claim 1, wherein the hydrophilic interaction liquid chromatography (HILIC) is performed by means of a step A and a step B between which there is a pH gradient from 2.5 to 7.5 and an ionic strength gradient from 15 mM to 200 mM such as to allow the separation of the analytes with a single stationary step.

13. The method according to claim 1, wherein the hydrophilic interaction liquid chromatography (HILIC) is performed by means of a step A with water, preferably R=18 MΩ 100% v/v and NH₄COOH, preferably 10 mM followed by a step B with acetonitrile, preferably MS grade 95% v/v and water, preferably R=18 MΩ 5% v/v and NH₄COOH, preferably 10 mM.

14. The method according to claim 1, wherein the analysis by mass tandem spectrometry is performed with the following parameters Q1 and Q3:

| Substance | Q1 | Q3 |
|---|---|---|
| Alanine | 44.1 | 72.1 |
| Aminoadipic acid | 98.1 | 144.1 |
| Aminobutyric acid | 41.1 | 58.1 |
| Aminoisobutyric acid | 57.1 | 86.1 |
| Hydroxyproline | 68.1 | 86.1 |
| Phosphoserine | 70.1 | 88.1 |
| Phosphoethanolamine | 44.1 | |
| Arginine | 70.1 | 116.1 |
| Hystidine | 110.1 | 83.1 |
| Lysine | 84.1 | 130.1 |
| Aspartic acid | 74.1 | 88.1 |
| Asparagine | 74.1 | 87.1 |
| Glutamine | 84.2 | 130.1 |
| Tryptophan | 146.1 | 188.1 |
| Argininosuccinic acid | 70.1 | 116.1 |
| Anserine | 109.1 | |
| Carnosine | 110.1 | 210.1 |
| Ethanolamine | 44.1 | |
| Hydroxylisine | 82.2 | 128.1 |
| Ornitine | 70.1 | 116.1 |
| Phenylalanine | 120.1 | 103.1 |
| Proline | 70.1 | 43 |
| Leucine | 86.1 | 43.1 |
| Isoleucine | 86.1 | 69.1 |
| Alloisoleucine | 69.1 | 86.1 |
| Homocitrulline | 127.1 | 173.1 |
| Citrulline | 70.1 | 159.1 |
| Sarcosine | 44.1 | |
| Threonine | 74.1 | 102.1 |
| Tyrosine | 136.1 | 165.1 |
| Valine | 72.1 | 55.1 |
| Lipoic acid | 205 | 171 |
| | 205 | 127.1 |
| | 205 | 93 |
| Methionine sulfoxide | 164 | 63 |
| | 164 | 100 |
| | 164 | 149 |
| | 166 | 74 |
| | 166 | 102 |
| | 166 | 149 |
| Cysteine_NEM | 247 | 158 |
| | 247 | 184 |
| | 247 | 230 |
| | 247 | 212 |
| N-acetylcysteine_NEM | 289 | 243 |
| | 289 | 201 |
| | 289 | 158.2 |
| Methionine SO2 | 180 | 79 |
| | 180 | 64 |
| Cysteic acid | 168 | 151 |
| | 168 | 81 |
| | 168 | 71 |
| Glycine | 74 | 45 |
| | 74 | 58 |
| Glutamic acid | 146 | 102 |
| | 146 | 128 |
| Methionine | 150 | 133 |
| | 150 | 104 |
| S-Adenosilhomocysteine | 383.2 | 134 |
| | 383.2 | 188 |
| | 383.2 | 248 |
| | 385 | 136 |
| | 385 | 250 |
| | 385 | 88 |
| Pyruvic acid | 87 | 43 |
| | 87 | 59 |
| Taurine | 124 | 80 |
| | 124 | 107 |
| Glutathione disulfide | 613 | 355 |
| | 613 | 484 |
| | 613 | 409 |
| | 613 | 538 |
| | 613 | 595 |
| | 611.3 | 306 |
| | 611.3 | 272.3 |
| | 611.3 | 254 |
| | 611.3 | 338 |
| | 611.3 | 143 |
| Glutathione_NEM | 431.1 | 306.3 |
| | 431.1 | 253.8 |
| | 431.1 | 288.2 |
| | 431.1 | 179 |
| | 431.1 | 272.2 |
| | 431.1 | 304.3 |
| | 431.1 | 286.9 |
| | 431.1 | 358.2 |
| | 431.1 | 201 |
| | 431.1 | 211.8 |
| Cysteine Sulfate | 200.3 | 136.1 |
| | 200.3 | 81 |
| | 200.3 | 74 |
| | 200.3 | 120 |
| N-formylmethionine | 176 | 128.1 |
| | 176 | 98 |
| | 176 | 84 |
| S-Adenosilmethionine | 399.3 | 298.1 |
| | 399.3 | 250.2 |
| | 399.3 | 264 |
| Serine | 103.9 | 74 |
| | 103.9 | 56 |
| | 103.9 | 42 |
| Cystathionine | 221 | 134 |
| | 221 | 120 |
| | 221 | 86 |
| Homocysteine-NEM | 261.1 | 215 |
| | 261.1 | 244 |
| Aminoethylcysteine | 165 | 148 |
| | 165 | 120 |
| Homocysteine | 267 | 132 |
| | 267 | 72 |
| | 267 | 115 |
| | 267 | 88 |
| Homoglutathione_NEM | 447.6 | 319 |
| | 447.6 | 301.3 |
| | 447.6 | 200.8 |
| | 447.6 | 358.1 |
| | 445.5 | 157.1 |
| | 445.5 | 286.3 |
| | 445.5 | 174 |
| | 445.5 | 196 |
| | 445.5 | 268.3 |
| | 445.5 | 301.9 |
| Selenomethionine | 197.1 | 95 |
| | 197.1 | 107 |
| | 197.1 | 122 |
| Cysteine | 241.2 | 120 |
| | 241.2 | 122 |
| | 241.2 | 152 |
| | 241.2 | 195 |
| | 241.2 | 223 |
| Homocysteine NMM | 247.1 | 215 |
| | 247.1 | 244 |
